(19) United States
(12) Patent Application Publication
(10) Pub. No.: US 2010/0106951 A1
(43) Pub. Date: Apr. 29, 2010

(54) COMPUTER SYSTEM AND METHOD FOR TRANSMITTING SYSTEM INFORMATION OF CONFIGURATION MANAGEMENT PROGRAM THEREOF

(75) Inventors: Ying-Chih Lu, Taipei City (TW); Wen-Ping Huang, Taipei City (TW); Po-Chin Yang, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/390,101

(22) Filed: Feb. 20, 2009

(30) Foreign Application Priority Data
Oct. 28, 2008 (TW) 97141467

(51) Int. Cl. G06F 15/177

(52) U.S. Cl. 713/1

(57) ABSTRACT

A computer system and a method for a configuration management program transmitting a system information are provided. The method includes the following steps. A first memory is provided, wherein the first memory records at least one system information. An interrupt is enabled from the configuration management program when the configuration management program needs a system information of the computer system, wherein the interrupt has a corresponding command information. An interrupt processing program processes the interrupt so as to perform a corresponding configuration setting operation according to the command information or to return the corresponding system information in the first memory to the configuration management program.

### CROSS-REFERENCE TO RELATED APPLICATION

This application claims the priority benefit of Taiwan application serial no. 97141467, filed on Oct. 28, 2008. The entirety of the above-mentioned patent application is hereby incorporated by reference herein and made a part of specification.

### BACKGROUND OF THE INVENTION

1. Field of the Invention

The present invention relates to a configuration management program, especially a computer system and a method for a configuration management program thereof transmitting a system information.

2. Description of Related Art

Advanced configuration and power interfaces (ACPI) are now widely applied in various sorts of computer platforms, including network servers, personal desktop computers and notebook computers. In current development tasks of functions of ACPI, ACPI source languages (ASL) are mostly used in industry to write function modules of ACPI, and ASL source codes need to be compiled into ACPI machine language (AML) codes of machine code forms. The AML codes are then burned into flash read only memories, and operating systems (OS) of ACPI are used to execute required functions of power management.

In addition, AML programs of ACPI often require generating corresponding data exchange relationships with basic input output systems (BIOS). Currently, in development of functions of a BIOS, C program language or assembly languages are used, so when computer engineers are developing a function of an ACPI, ASL program languages are required to write ASL codes, and C program language (or assembly languages) is required to write related codes of the BIOS.

Since ASL and C program languages (or assembly languages) are languages having completely different syntaxes, there are great inconvenience and trouble to computer engineers (who are developers of ACPI). In other words, when chipsets in computer systems need to be replaced, hardware designs need to be modified or codes of a BIOS need to be corrected, not only the related codes of the BIOS need to be corrected by a computer engineer, related ASL codes also need to be corrected, so that the computer systems can operate normally.

In light of the above, providing a technology that applies ASL codes of a single version to different product cases, or even to different chipsets and different hardware environments, so that computer engineers do not need to additionally correct the ASL codes and correction time for correcting the ASL codes is reduced, is an important issue.

### SUMMARY OF THE INVENTION

The present invention provides a computer system and a method for a configuration management program obtaining a system information, so that when computer engineers perform modifications on hardware or BIOS, related ASL/AML codes of the configuration management program need not be modified, so that errors and debugging time of writing the ASL/AML codes are reduced.

The present invention provides a method for a configuration management program transmitting a system information which includes the following steps. First, a first memory is provided, wherein the first memory records at least one system information. Then, an interrupt is enabled from the configuration management program, wherein the interrupt has a command information. Next, the interrupt is processed by an interrupt processing program so that the interrupt processing program performs a corresponding configuration setting operation according to the command information in the interrupt or returns the corresponding system information in the first memory to the configuration management program according to the command information.

According to an embodiment of the present invention, the above method further includes the following steps. First, the computer system is tested to obtain at least one system information. Next, the system information is recorded in the first memory.

According to an embodiment of the present invention, the above step of testing the computer system includes the following steps. First, a power-on self-test (POST) procedure is performed. Next, in the POST procedure, a configuration of the computer system is tested by a BIOS to obtain the system information.

According to an embodiment of the present invention, the above interrupt is a system management interrupt (SMI), and the interrupt processing program is an SMI handler.

According to an embodiment of the present invention, the above command information includes a command, and the above step of enabling the interrupt from the configuration management program includes writing the command to an interrupt control port, wherein the interrupt processing program executes the command in the interrupt control port, so as to perform a corresponding configuration setting operation according to the command or to return the corresponding system information in the first memory to the configuration management program.

According to an embodiment of the present invention, the above command information includes the command and a first parameter, and the step of enabling the interrupt from the configuration management program includes the following steps. The first parameter is written to an interrupt data port. Next, the command is written to the interrupt control port. The interrupt processing program executes the command in the interrupt control port according to the first parameter in the interrupt data port so as to perform the corresponding configuration setting operation according to the first parameter and the command or to write the corresponding system information in the first memory to the interrupt data port according to the first parameter and the command.

According to an embodiment of the present invention, the above method for the configuration management program transmitting the system information further includes reading the system information from the interrupt data port by the configuration management program.

According to an embodiment of the present invention, the above interrupt data port is an input output (IO) port having an address of B3h.

According to an embodiment of the present invention, the above interrupt control port is an IO port having an address of B2h.

According to an embodiment of the present invention, the step of enabling the interrupt from the configuration management program further includes writing a second parameter to a second memory, wherein the interrupt processing program executes the command in the interrupt control port according to the first parameter in the interrupt data port and the second parameter in the second memory, so as to perform the corresponding configuration setting operation according to the first parameter, the second parameter and the command or to write the corresponding system information in the first memory to the second memory according to the first parameter, the second parameter and the command.

According to an embodiment of the present invention, the above method for the configuration management program transmitting the system information further includes reading the system information from the second memory by the configuration management program.

According to an embodiment of the present invention, the above second memory is an extended BIOS data area (EBDA).

According to an embodiment of the present invention, the above first memory is a system management mode random access memory (SMM RAM).

According to an embodiment of the present invention, the above configuration management program is a program of an ACPI.

The present invention provides a computer accessible storage medium used for storing a computer program. The computer program is loaded into the computer system and enables the computer system to execute the above method for the configuration management program transmitting the system information.

The present invention provides a product of a computer program for the configuration management program transmitting the system information. After a computer loads and executes the computer program, the above method for the configuration management program transmitting the system information is completed.

The present invention provides a computer system which includes a testing module, a memory and a configuration management program module and an interrupt processing program module. The testing module is used to test the computer system to obtain at least one system information. The memory is used to store the system information. The configuration management program module is used to execute a configuration management program so as to enable an interrupt, wherein the interrupt has a command information. The interrupt processing program module is used to execute an interrupt processing program to process the interrupt, so as to perform a corresponding configuration setting operation according to the command information or to return the corresponding system information in the memory to the configuration management program module according to the command information.

According to an embodiment of the present invention, the above computer system further includes a testing module. The testing module is used to test the computer system so as to obtain at least one system information, and store the system information in a first memory.

According to an embodiment of the present invention, the above testing module performs a POST procedure, and in the POST procedure, tests a configuration of the computer system through the BIOS to obtain the system information.

According to an embodiment of the present invention, the above interrupt is an SMI, and the interrupt processing program is an SMI handler.

According to an embodiment of the present invention, the above command information includes a command, and the computer system further includes an interrupt control port. The interrupt control port is used to store the command, wherein the interrupt processing program module executes the command in the interrupt control port, so that a corresponding configuration setting operation is performed or the corresponding system information in the first memory is returned to the configuration management program module.

According to an embodiment of the present invention, the above command information includes the command and the first parameter, and the computer system further includes an interrupt data port and the interrupt control port. The interrupt data port is used to store the first parameter. The interrupt control port is used to store the command. The interrupt processing program module executes the command in the interrupt control port according to the first parameter in the interrupt data port so as to perform the corresponding configuration setting operation according to the first parameter and the command or to write the corresponding system information in the first memory to the interrupt data port according to the first parameter and the command.

According to an embodiment of the present invention, the above configuration management program module reads the system information from the interrupt data port.

According to an embodiment of the present invention, the above interrupt data port is an IO port having an address of B3h.

According to an embodiment of the present invention, the above interrupt control port is an IO port having an address of B2h.

According to an embodiment of the present invention, the above computer system further includes the second memory to which the second parameter is stored. The interrupt processing program executes the command in the interrupt control port according to the first parameter in the interrupt data port and the second parameter in the second memory so as to perform the corresponding configuration setting operation according to the first parameter, the second parameter and the command or to write the corresponding system information in the first memory to the second memory according to the first parameter, the second parameter and the command.

According to an embodiment of the present invention, the above configuration management program module reads the system information from the second memory.

The present invention first stores the system information obtained by testing the computer system in the memory. Then, the interrupt is enabled from the configuration management program, and the interrupt is processed by the interrupt processing program, so as to perform the corresponding configuration setting operation according to the command information in the interrupt or to return the corresponding system information in the memory according to the command information in the interrupt, so that the configuration management program obtains the corresponding system information. Therefore, if a chipset in the computer system need to be replaced, a hardware design needs to be modified or the codes of the BIOS need to be corrected, a computer engineer only needs to correct the related codes of the BIOS, and does not need to correct the ASL codes related to the configuration management program, thereby reducing the errors in writing the ASL codes and debugging time.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart showing a method for a configuration management system transmitting a system information according to an embodiment of the present invention.

FIG. 2 is a schematic view showing a computer system according to an embodiment of the present invention.

FIG. 3 is a flowchart showing a method for a configuration management system transmitting a system information according to another embodiment of the present invention.

FIG. 4 is a schematic view showing a computer system according to another embodiment of the present invention.

FIG. 5 is a flowchart showing a method for a configuration management system transmitting a system information according to still another embodiment of the present invention.

FIG. 6 is a schematic view showing a computer system according to still another embodiment of the present invention.

FIG. 7 is a flowchart showing a method for a configuration management system transmitting a system information according to yet another embodiment of the present invention.

FIG. 8 is a schematic view showing a computer system according to yet another embodiment of the present invention.

### DESCRIPTION OF EMBODIMENTS

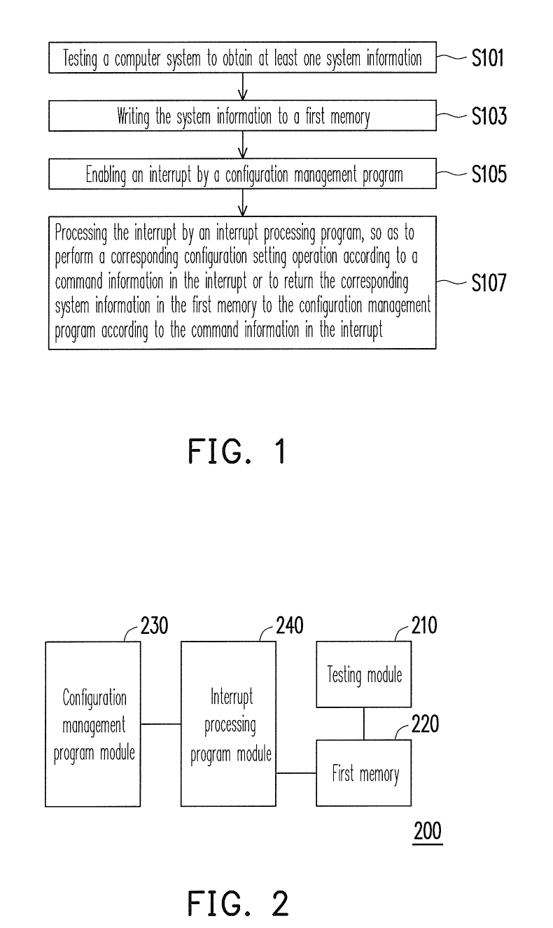

FIG. 1 is a flowchart showing a method for a configuration management system transmitting a system information according to an embodiment of the present invention. FIG. 2 is a schematic view showing a computer system according to an embodiment of the present invention. Referring to both FIGS. 1 and 2, a computer system 200 includes a testing module 210, a first memory 220, a configuration management program module 230 and an interrupt processing program module 240. The testing module 210 is used to test the computer system 200 to obtain at least one system information (step S101). According to the present embodiment, a non-volatile random access memory (NVRAM) may be disposed in the testing module 210, and the NVRAM is used to store a BIOS. Hence, the testing module 210 first performs a POST procedure, and in the POST procedure, tests a configuration of the computer system 200 through the BIOS to obtain a required system information. The above required system information may be various sorts of related information of communication ports COM1/COM2, PS2-KB/MS, a wakeup on ring (WOR), a wakeup on LAN (WOL), stopping a fan, setting a power LED state or a baseboard management controller (BMC).

Next, after obtaining the system information, the testing module 210 writes the obtained system information in the first memory 220 (step S103). This means that the first memory 220 stores the system information, so that the computer system 200 may read the system information from the first memory 220 in subsequent operations. According to the present embodiment, the above first memory is, for example, an SMM RAM.

The configuration management program module 230 executes a configuration management program. When the configuration management program is to transmit the system information to execute configuration management, the configuration management program of the configuration management program module 230 enables an interrupt, wherein the interrupt has a command information (step S105). According to the present embodiment, the configuration management program of the configuration management program module 230 may be a program of an ACPI or any other configuration management program used to manage configurations in the computer system.

After receiving the above interrupt, the interrupt processing program module 240 executes an interrupt processing program to process the interrupt, so as to perform a corresponding configuration setting operation or to obtain a configuration message according to the command information in the interrupt. The above interrupt is, for example, an SMI, and the interrupt processing program executed by the interrupt processing program module 240 is, for example, an SMI handler.

In other words, by enabling the interrupt, the configuration management program module 230 may request the interrupt processing program module 240 to execute a part or all of the configuration setting operation according to the command information. In other words, the interrupt processing program module 240 generates a setting value according to the command information in the above interrupt, so as to perform the configuration setting operation (for example setting a fan speed or other configurations). Alternatively, by enabling the interrupt, the configuration management program module 230 may also request the interrupt processing program module 240 to read the corresponding system information (which is the configuration message, such as reading a setting value of a “WOL”, or a setting value of other configurations) in the first memory 220 according to the command information and return the system information to the configuration management program module 230 (step S107), so that the configuration management program obtains the corresponding system information. Therefore, a computer engineer does not have to modify codes of the configuration management program module 230 when programs codes in hardware or in the BIOS need to be modified.

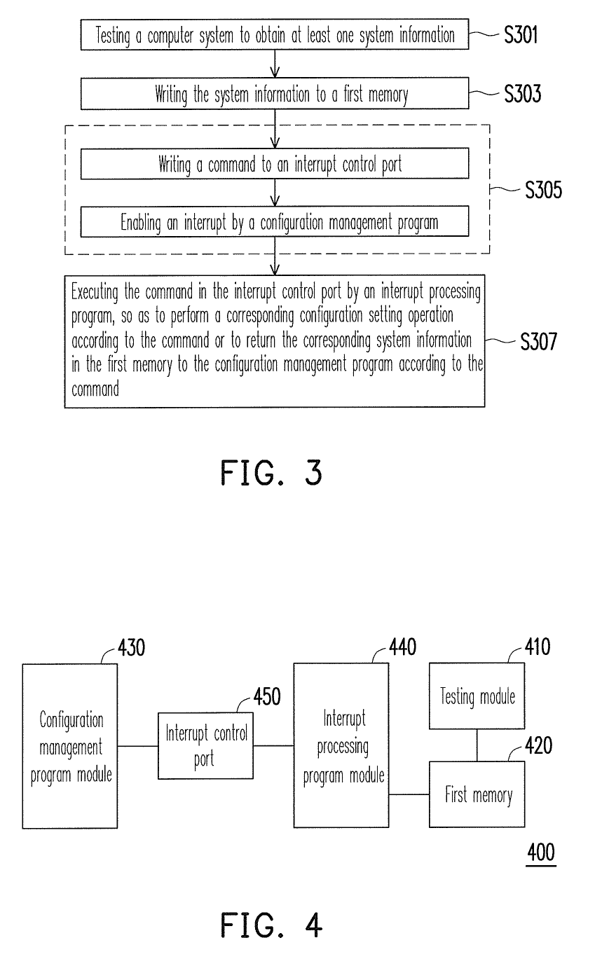

FIG. 3 is a flowchart showing a method for a configuration management system transmitting a system information according to another embodiment of the present invention. FIG. 4 is a schematic view showing a computer system according to another embodiment of the present invention. Referring to both FIGS. 3 and 4, a computer system 400 includes a testing module 410, a first memory 420, a configuration management program module 430, an interrupt processing program module 440 and an interrupt control port 450. According to the present embodiment, the testing module 410, the first memory 420, the configuration management program module 430 and the interrupt processing program module 440 may refer to the following description or respectively refer to the related descriptions of the testing module 210, the first memory 220, the configuration management program module 230 and the interrupt processing program module 240 in FIG. 2.

The testing module 410 is used to test the computer system 400 to obtain at least one system information (step S301). Next, the testing module 410 writes the system information to the first memory 420 (step S303), so that the computer system 400 reads the system information from the first memory 420 in subsequent operations. According to the present embodiment, the first memory 420 is, for example, an SMM RAM. Then, the configuration management program module 430 writes a command to the interrupt control port 450, and executes a configuration management program to enable an interrupt, wherein the interrupt has the above command (step S305). The above interrupt is, for example, an SMI, and the interrupt control port 450 may be an SMI control port.

Afterwards, after receiving the above interrupt, the interrupt processing program module 430 reads the above command from the interrupt control port 450, so as to execute an interrupt processing program to process the command in the interrupt control port 450 and to return the corresponding system information in the first memory 420 to the configuration management program module 430 (step S307), so that the configuration management program obtains the corresponding system information. Alternatively, the interrupt processing program module 440 executes the command in the interrupt control port 450 according to a first parameter, and performs a corresponding configuration setting operation. Therefore, a computer engineer does not have to modify codes of the configuration management program module 430 when programs codes in hardware or in a BIOS of the computer system 400 need to be modified.

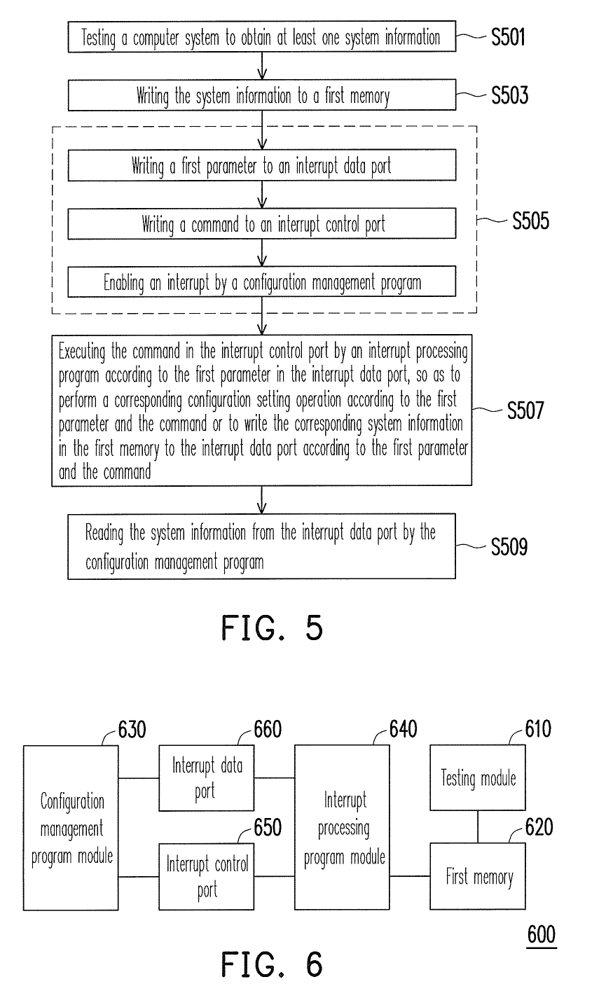

FIG. 5 is a flowchart showing a method for a configuration management system transmitting a system information according to still another embodiment of the present invention. FIG. 6 is a schematic view showing a computer system according to still another embodiment of the present invention. Referring to both FIGS. 5 and 6, a computer system 600 includes a testing module 610, a first memory 620, a configuration management program module 630, an interrupt processing program module 640, an interrupt control port 650 and an interrupt data port 660. According to the present embodiment, the testing module 610, the first memory 620, the configuration management program module 630, the interrupt processing program module 640 and the interrupt control port 650 may refer to the following description or respectively refer to the related descriptions of the testing module 410, the first memory 420, the configuration management program module 430, the interrupt processing program module 440 and the interrupt control port 450 in FIG. 4.

The testing module 610 is used to test the computer system 600 to obtain at least one system information (step S501). Next, the testing module 610 writes the system information to the first memory 620 (step S503), so that the computer system 600 reads the system information from the first memory 620 in subsequent operations. According to the present embodiment, the first memory 620 is, for example, an SMM RAM.

Afterwards, the configuration management program module 630 writes a first parameter to the interrupt data port 660, then writes a command to the interrupt control port 650, and executes a configuration management program to enable an interrupt, wherein the interrupt has the above first parameter and the command (step S505). The above interrupt is, for example, and SMI, and the interrupt data port 660 and the interrupt control port 650 may be an SMI data port and an SMI control port.

After the interrupt processing program module 640 receives the above interrupt, the interrupt processing program module 640 respectively reads the first parameter and the command from the interrupt data port 660 and the interrupt control port 650, so as to execute the command in the interrupt control port 650 according to the first parameter in the interrupt data port 660 and write the corresponding system information in the first memory 620 to the interrupt data port 660 (step S507). Alternatively, the interrupt processing program module 640 executes the command in the interrupt control port 650 and performs a corresponding configuration setting operation according to the first parameter. Last, the configuration management program module 630 reads the system information from the interrupt data port 660 (step S509), so that the configuration management program obtains the corresponding system information. Therefore, a computer engineer does not have to modify codes of the configuration management program module 630 when programs codes in hardware or in the BIOS of the computer system 600 need to be modified. According to the present embodiment, the interrupt data port 660 is, for example, an 8-bit IO port having an address of B3h, and the interrupt control port 650 is, for example, an 8-bit IO port having an address of B2h.

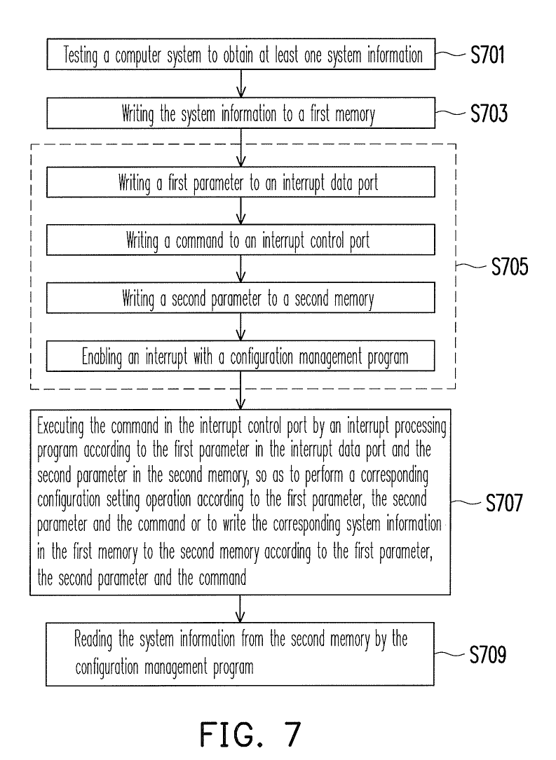

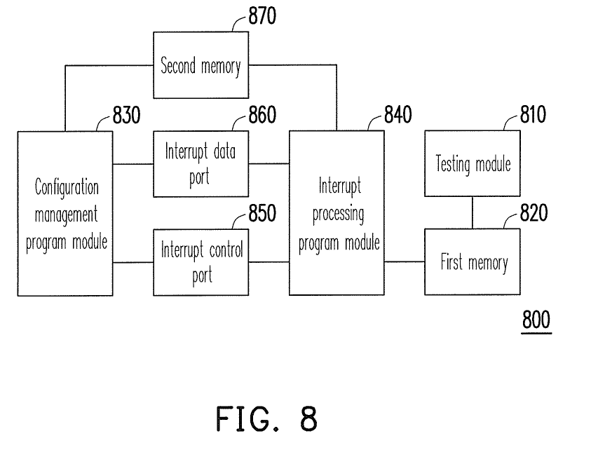

According to the above embodiment, a size of data that the interrupt data port 660 is able to store is 8 bits. When a size of data written to a parameter by the configuration management program module 630 is larger than 8 bits, according to the above embodiment, the interrupt data port 660 cannot fully store the above parameter. Therefore, another embodiment is described in the following. FIG. 7 is a flowchart showing a method for a configuration management system transmitting a system information according to yet another embodiment of the present invention. FIG. 8 is a schematic view showing a computer system according to yet another embodiment of the present invention. First referring to FIG. 8, a computer system 800 includes a testing module 810, a first memory 820, a configuration management program module 830, an interrupt processing program module 840, an interrupt control port 850, an interrupt data port 860 and a second memory 870. According to the present embodiment, the testing module 810, the first memory 820, the configuration management program module 830, the interrupt processing program module 840 and the interrupt control port 850 may refer to the following description or respectively refer to the related description of the testing module 610, the first memory 620, the configuration management program module 630, the interrupt processing program module 640 and the interrupt control port 650 in FIG. 6. The second memory 870 stores a parameter having larger data, for example, 1 kilobyte.

Referring to both FIGS. 7 and 8, descriptions of steps S701 and S703 are the same or similar to descriptions of the steps S501 and S503 and are not repeatedly described. Next, in the step S705, besides writing the first parameter (8-bit) to the interrupt data port 860 and writing the command to the interrupt control port 850, the configuration management program module 830 also writes the second parameter to the second memory 870.

Afterwards, in the step S707, after receiving the interrupt, besides first reading the first parameter from the interrupt data port 860 and the command from the interrupt control port 850, the interrupt processing program module 840 also reads a second parameter from the second memory 870, so as to execute the command in the interrupt control port 850 according to the first parameter and the second parameter and to write the corresponding system information in the first memory 820 to the second memory 870. Alternatively, the interrupt processing program module 840 may execute the command in the interrupt control port 850 according to the first parameter in the interrupt data port 860 and the second parameter in the second memory 870 and perform a corresponding configuration setting operation (such as setting a fan speed, or setting other configuration parameters). Here it is presumed that after receiving the interrupt, the interrupt processing program module 840 executes the command in the interrupt control port 850 according to the first parameter and the second parameter and writes the corresponding system information in the first memory 820 to the second memory 870.

Last, in step S709, the configuration management program module 830 reads the system information from the second memory 870, so that a configuration management program obtains the corresponding system information. According to the present embodiment, the above second memory is an EBDA. The EBDA contains data capacity up to 1024 bytes.

The following uses some practical examples for description. Before the computer system 600 (800) enters a sleep state, tasks in two time points need to be executed by the BIOS. The first time point is when a _PTS method in an ACPI is executed, meaning that a software system management interrupt (SW SMI) is used to make the BIOS execute some functions, such as enabling a PS2 KB/MS wakeup, clearing a wakeup status, stopping a fan and setting a power LED state. The SW SMI requires an input data and an output result. The above input data is the first parameter and the command according to the present embodiment, and the output result is the system information according to the present embodiment. Additionally, a program that executes above function is shown in the following:

EX :
Method (_PTS, 1, NotSerialized)
{
if (Lor(LEqual(ARG0, 4),LEqual(ARG0, 5))) //S4 or S5

| | |
|---|---|
| { \_SB.SSMI(0xAF, 0) | // issue sw smi 0xAF subfunction 0 to Enable SIO wakeup on ring on |
| | COMA |
| \_SB.SSMI(0xAF, 2) | // issue sw smi 0xAF subfunction 2 to Enable SIO wakeup on ring on |
| | COMB |
| } | |
| if (LEqual(ARG0, 1)) | // While entering S1 |
| { | |

```
  if (Lor(\_SB.WPSK, \_SB.WPSM))  // PS2 KB/MS will can wakeup from S1
  {
```

| | |
|---|---|
| \_SB.SSMI(0xAF,4) | // issue sw smi 0xAF subfunction 4 to Enaable SIO wakeup on PS2 KB |
| \_SB.SSMI(0xAF,6) | // issue sw smi 0xAF subfunction 6 to Enable SIO wakeup on PS2 MS |
| } | |
| \_SB.SSMI(0xAF,0) | // issue sw smi 0xAF subfunction 0 to Enable SIO wakeup on ring on |
| | COMA |
| \_SB.SSMI(0xAF,2) | // issue sw smi 0xAF subfunction 2 to Enable SIO wakeup on ring on |
| | COMB |
| } | // end if |
| ... | |
| Store(One, PS1S) | // Clear Sleep status |
| Store(One, PS1E) | // Enable Sleep |

//After here, system will issue “Sleep SMI”if“sleep type enable bit” is set as 1
} //end of_PTS

Furthermore, the second time point is a final point when the computer system 600 (800) enters the sleep state, which is when an enable bit of a sleep register is written to 1.

The BIOS must use an IO trap or a sleep type register to intercept the SMI, so as to execute related tasks. Above functions are, for example, enabling a PS2 KB/MS wakeup event, a WOC and a WOL.

Moreover, tasks in a time point after the computer system 600 (800) leaves the sleep state must be executed by the BIOS, which are tasks executed by the SW SMI when a_WAK method in the ACPI is executed, for example clearing a status, disabling a wakeup event, restoring a fan and setting a power LED state. A program that executes above function is shown in the following:

| | |
|---|---|
| Ex : | |
| Method(_WAK, 1, Serialized) | |
| { | |
| \_SB.SSMI(0xAF, 1) | // issue sw smi 0xAF subfunction |
| | 1 to disable SIO wakeup on ring |
| | on COMA |
| \_SB.SSMI(0xAF,3) | // issue sw smi 0xAF subfunction |
| | 3 to disable SIO wakeup on ring |
| | on COMB |
| \_SB.SSMI(0xAF,5) | // issue sw smi 0xAF subfunction |
| | 5 to disable SIO wakeup on PS2 KB |
| \_SB.SSMI(0xAF,7) | // issue sw smi 0xAF subfunction |
| | 7 to disable SIO wakeup on PS2 MS |
| ... | |
| } | |

According to the present embodiment, ASL codes only have a single procedure of enabling the SW SMI. Two parameters need to be input in the above procedure (a command and an input parameter), which are the first parameter and the command according to the present embodiment, and an output value is returned after executing the above procedure, which is the system information according to the present embodiment. Therefore, it is sufficient to define corresponding relationships between the command (the interrupt control port 650 (850), an SMI command port OB2h)/the input parameter (the interrupt data port 660 (860), an SMI data port OB3h)/the output parameter (the interrupt data port 660 (860), the SMI data port OB3h). Additionally, the command/the input data/the output data are all 8-bit. A program that executes above functions is shown in the following:

EX :
//
// Alg - issue SW SMI with command ARG0(8 bits) & input data ARG1(8 bits), and return a value
(8bits)

| | |
|---|---|
| // EX : | SW SMI 0xAF with parameter input parameter |
| // | 0:Enable SIO COMA wake on Ring (EnableSioComaWOR) |
| // | 1: Disable SIO COMA wake on Ring (DisableSioComaWOR) |
| // | 2: Enable SIO COMB wake on Ring (EnableSioCombWOR) |
| // | 3: Disable SIO COMB wake on Ring (DisableSioCombWOR) |
| // | 4: Enable SIO PS2 KB wakeup (EnableSioPs2Kb) |
| // | 5: Disable SIO PS2 KB wakeup (DisableSioPs2Kb) |
| // | 6: Enable SIO PS2 MS wakeup (EnableSioPs2Ms) |
| // | 7: Disable SIO PS2 MS wakeup (DisableSioPs2Ms) |
| // | |

Method (SSMI,2) // SW SMI
{
Mutex (MUT1, 0) // MUTEX for SMIS(IO 0x B3) & SMIC (IO 0xB2)

| | |
|---|---|
| Acquire(MUT1, 0xFFFF) | // Acquire Semaphore |
| Store(\_SB.SMIS, Local0) | // Save SMIS |
| Store(Arg1,\_SB.SMIS) | // Set parameter into SMIS |
| Store(Arg0,\_SB.SMIC) | // SW SMI command into SMIC; issue SW SMI & return value will |
| | save to IO 0xB3 |
| Store(\_SB.SMIS , Local1) | |
| Store(Local0, \_SB.SMIS) | // Restore SMIS |
| Release(MUT1) | // Release Semaphore |
| Return (Local1) | |
| } | // end SSMI |

OperationRegion (IOB2, SystemIO, 0xB2, 2) // MKF_SMIPORT
Field (IOB2, ByteAcc, NoLock, Preserve)
{

| | |
|---|---|
| SMIC, 8, | // SW-SMI ctrl port |
| SMIS, 8, | // SW-SMI Data port |
| } | |

Moreover, according to the present embodiment, if the system information is obtained through a method for the SW SMI from the testing module (the BIOS) 610 (810), the ASL codes do not need to be modified when modifying data in the BIOS. This is shown in the following example:
Memory32Fixed(ReadOnly, 0x0FEC00000, 0x0100)//IO APIC IO(Decode16, 0x0, 0x0, 0, 0x10)

A memory mapped input output (MMIO) base address 0x0FEC00000 and an IO port base address 0x0 may be obtained from the testing module 610 (810) through the method for the SW SMI and the EBDA.

In addition, the AML codes and the BIOS may exchange large amounts of data, according to the present embodiment, by using the second memory 870. Moreover, during a self-test procedure of the BIOS, a largest and standardized memory space (for example 1 kilobyte) is reserved as a data area for exchange. The AML codes obtain a memory address of the data area through the SW SMI, and a program thereof is described in the following.

```
Ex :
Name(EBAD,0) // Memory base
OperationRegion(EBDA, SystemMemory,
EBAD, 0x1)  // EBDA Base Address
Field(EBDA, ByteAcc, NoLock, Preserve)
{
    DAT0, 8,
    DAT1,8,
    DAT2,8,
    ...
    DATn,8
}
Scope(_SB)
{
  Method(_INI, 0)
  {
  Store( SSMI(0xAD, 0), EBAD)  // issue SW
  SMI 0xAD with input parameter 0 to get EBDA
  base
  SHL (EBAD, 8)
  ...
  }
}
```

Before calling the SW SMI, data to be sent in is written to the second memory 870, meaning that the configuration management program module 830 needs to write a first data to the second memory 870. After executing the SW SMI, the interrupt processing program module 840 executes the command in the interrupt control port 850 according to the first parameter in the control data port and the second parameter in the second memory 870, so as to read the corresponding system information from the first memory 820 and to write the system information to the second memory 870. A program that has above functions is shown in the following:

EX : // Input Parameters
Store (0, DAT0)
Store (1, DAT1)
...
Store (n, DATn)
SSMI(0xFD, 0) // issue SW SMI
// Get return values
Store(DAT0, Local0)

Tables 1 to 6 are reference tables showing various sorts of commands, the first parameter, the second parameter and the system information in the interrupt processing program. An SMI mechanism is the SW SMI and a sleep type SMI; “both” indicates having two modes of the SW SMI and the sleep type SMI at the same time. A “command” column indicates the command in the interrupt control port 650 (850); a “first parameter” column indicates the first parameter written to the interrupt data port 660 (860); a “second parameter” column indicates the second parameter written to the second memory; a “returned system information” column indicates the system information returned to the configuration management program module 630 (830) by the interrupt processing program module 640 (840) according to the “command” accompanied in the interrupt; an “action” column indicates an action corresponding to the “command”; a “corresponding procedure in SMI handler” column indicates an internally executed corresponding procedure by the SMI handler according to the “command” accompanied in the interrupt.

The following uses data in gray areas in Table 1 for description. Referring to both Tables 1 and FIG. 6, here it is presumed that the command information includes the command and the first parameter. When the configuration management program module 630 writes the first parameter “OBh” to the interrupt data port 660 (the address thereof is B3h) and writes the command “AFh” to the interrupt control port 650 (the address thereof is B2h), the SMI mechanism used at the moment is the SW SMI, and a setting value of the WOL in the computer system 600 is to be obtained. After respectively filling the first parameter “OBh” and the command “AFh” in the interrupt data port 660 and the interrupt control port 650, the configuration management program module 630 enables the SMI. This means that the interrupt has the first parameter “OBh” and the command “AFh”.

Next, after receiving the above SMI, the interrupt processing program module 640 executes the command “AFh” in the interrupt control port 650 according to the first parameter “OBh” in the interrupt data port 660, so as to read the setting value of the “WOL” (the corresponding system information) from the first memory 620 and to write the system information to the interrupt data port 660 (the step S507). According to another embodiment, the SMI handler (the interrupt processing program module 640) may execute the command “AFh” in the interrupt control port 650 according to the first parameter “OB” in the interrupt data port 660, so as to call a corresponding “GetWOLSts” procedure to obtain the setting value of the “WOL” in the computer system 600. Last, the configuration management program module 630 reads the system information in the interrupt data port 660 (the step S509), so that the configuration management program obtains the corresponding system information.

According to the present embodiment, in the above step S507, if the system information (the setting value of the “WOL”) written to the interrupt data port 660 is “0”, it means that the computer system 600 disables the “WOL”. In the above step S507, if the system information (the setting value of the “WOL”) written to the interrupt data port 660 is “1”, it means that the computer system 600 may be awaken by the WOL (a function of the “WOL” is enabled).

Furthermore, another example is presented for description. Here it is presumed that the command information includes the command, the first parameter and the second parameter. Referring to both Table 6 and FIG. 8, when the configuration management program module 830 writes the first parameter “Oh” to the interrupt data port 860 (the address thereof is B3h), writes the command “FAh” to the interrupt control port 850 (the address thereof is B2h) and writes the second parameter “Oh” to the second memory 870, the SMI mechanism used at the moment is the SW SMI and is to be performed the corresponding configuration setting operation on the configuration management program module 830 according to a setting value of sending a running OS type to the SMI handler in the BIOS from the ACPI OS. After respectively filling the first parameter “Oh”, the command “FAh” and the second parameter “Oh” in the interrupt data port 860, the interrupt control port 850 and the second memory 870, the configuration management program module 830 may enable the SMI. This means that the interrupt has the first parameter “Oh”, the command “FAh” and the second parameter “Oh”.

Next, after receiving the above SMI, the interrupt processing program module 840 executes the command “FAh” in the interrupt control port 850 according to the first parameter “Oh” in the interrupt data port 860 and the second parameter “Oh” in the second memory 870, so as to read the setting value (the corresponding system information) of sending the running OS type to the SMI handler in the BIOS from the ACPI OS and to write the system information to the second memory 870 (the step S707). According to another embodiment, the SMI handler (the interrupt processing program module 840) may execute the command “FAh” in the interrupt control port 850 according to the first parameter “Oh” in the interrupt data port 860 and the second parameter “Oh” in the second memory 870, so as to call a corresponding “SendRunningOsType” procedure to execute a configuration setting operation of the setting value of “sending the running OS type to the SMI handler in the BIOS from the ACPI OS”.

According to the present embodiment, in the above step S707, if the system information (the setting value of “sending the running OS type to the SMI handler in the BIOS from the ACPI OS”) written to the second memory 870 is “Oh”, it means that a OS type of the computer system 800 is “Windows XP”. In the above step S707, if the system information (the setting value of “sending the running OS type to the SMI handler in the BIOS from the ACPI OS”) written to the second memory 870 is “1h”, it means that the OS type of the computer system 800 is “Windows 2003 32 bit”. In the above step S707, if the system information (the setting value of “sending the running OS type to the SMI handler in the BIOS from the ACPI OS”) written to the second memory 870 is “2h”, it means that the OS type of the computer system 800 is “Windows 2003 64 bit”. In the above step S707, if the system information (the setting value of “sending the running OS type to the SMI handler in the BIOS from the ACPI OS”) written to the second memory 870 is “3h”, it means that the OS type of the computer system 800 is “Windows 2000”. In the above step S707, if the system information (the setting value of “sending the running OS type to the SMI handler in the BIOS from the ACPI OS”) written to the second memory 870 is “4h”, it means that the OS type of the computer system 800 is “NT 4.0”. In the above step S707, if the system information (the setting value of “sending the running OS type to the SMI handler in the BIOS from the ACPI OS”) written to the second memory 870 is “5h”, it means that the OS type of the computer system 800 is “Redhat Linux EL5 AS”. In the above step S707, if the system information (the setting value of “sending the running OS type to the SMI handler in the BIOS from the ACPI OS”) written to the second memory 870 is “6h”, it means that the OS type of the computer system 800 is “Fedora Core 8”. A person having ordinary skills in the art can deduce other corresponding relations through the above description, so repeated description is omitted here.

Tables 1 is a reference table showing the first parameter, the second parameter and the system information when the command is AFh in the interrupt processing program.

| | First | |
|---|---|---|
| Command/ | parameter/ | |
| SMI | second | Returned system information/action/ |
| mechanism | parameter | corresponding procedure in SMI handler |
| AFh | 0/NA | NA/Enable SIO COMA wake on Ring/ |
| (Wakeup | | EnableSioComaWOR |
| Event, Fan)/ | | |
| Sleep-type | | |
| SMI | | |
| AFh | 1/NA | NA/Disable SIO COMA wake on Ring/ |
| (Wakeup | | DisableSioComaWOR |
| Event, Fan)/ | | |
| SW SMI | | |
| AFh | 2/NA | NA/Enable SIO COMB wake on Ring/ |
| (Wakeup | | EnableSioCombWOR |
| Event, Fan)/ | | |
| Sleep-type | | |
| SMI | | |
| AFh | 3/NA | NA/Disable SIO COMB wake on Ring/ |
| (Wakeup | | EnableSioCombWOR |
| Event, Fan)/ | | |
| SW SMI | | |
| AFh | 4/NA | NA/Enable SIO PS2 KB wakeup/ |
| (Wakeup | | EnableSioPs2Kb |
| Event, Fan)/ | | |
| Both | | |
| AFh | 5/NA | NA/Disable SIO PS2 KB wakeup/ |
| (Wakeup | | DisableSioPs2Kb |
| Event, Fan)/ | | |
| SW SMI | | |
| AFh | 6/NA | NA/Enable SIO PS2 MS wakeup/ |
| (Wakeup | | EnableSioPs2Ms |
| Event, Fan)/ | | |
| Both | | |
| AFh | 7/NA | NA/Disable SIO PS2 MS wakeup/ |
| (Wakeup | | DisableSioPs2Ms |
| Event, Fan)/ | | |
| SW SMI | | |
| AFh | 8/NA | NA/Clear all wakeup event status/ |
| (Wakeup | | ClearAllWakEvtSts |
| Event, Fan)/ | | |
| Both | | |
| AFh | 9/NA | NA/Stop all fans and save all fans speed in |
| (Wakeup | | SMM RAM/StopAllFanWithSave |
| Event, Fan)/ | | |
| Both | | |
| AFh | 0A/NA | NA/Restore all fans speed per previous fan data |
| (Wakeup | | in SMM RAM/RestoreAllFanPreviousSpeed |
| Event, Fan)/ | | |
| SW SMI | | |
| AFh | 0B/NA | Port 3Bh (0 - No/1 - yes)/wakeup on LAN ?/ |
| (Wakeup | | GetWOLSts |
| Event, Fan)/ | | |
| SW SMI | | |
| AFh | 0C/NA | NA/Enable wakeup on LAN/EnableWOR |
| (Wakeup | | |
| Event, Fan)/ | | |
| Sleep-type | | |
| SMI | | |

Tables 2 is a reference table showing the first parameter, the second parameter and the system information when the command is AEh in the interrupt processing program.

| | First | |
|---|---|---|
| Command/ | parameter/ | |
| SMI | second | Returned system information/action/ |
| mechanism | parameter | corresponding procedure in SMI handler |
| AEh | 0/NA | Port B3h/Get COM A port status (enabled/ |
| (Onboard | | disabled)/GetComAPortSts |
| Legacy | | |
| Devices | | |
| status)/ | | |
| SWSMI | | |
| AEh | 1/NA | Port B3h/Get COM B port status (enabled/ |
| (Onboard | | disabled)/GetComBPortSts |
| Legacy | | |
| Devices | | |
| status)/ | | |
| SWSMI | | |
| AEh | 2/NA | Port B3h/Get Parallel port status (enabled/ |
| (Onboard | | disabled)/GetParallelPortSts |
| Legacy | | |
| Devices | | |
| status)/ | | |
| SW SMI | | |
| AEh | 3/NA | Port B3h/Get Floppy A status (enabled/ |
| (Onboard | | disabled)/GetFloppyPortSts |
| Legacy | | |
| Devices | | |
| status)/ | | |
| SW SMI | | |
| AEh | 4/NA | Port B3h/Get Floppy B status (enabled/ |
| (Onboard | | disabled)/GetFloppyPortSts |
| Legacy | | |
| Devices | | |
| status)/ | | |
| SW SMI | | |
| AEh | 5/NA | Port B3h/Get Power Button status (enabled/ |
| (Onboard | | disabled)/GetPwrButtonSts |
| Legacy | | |
| Devices | | |
| status)/ | | |
| SW SMI | | |

Tables 3 is a reference table showing the first parameter, the second parameter and the system information when the command is ADh in the interrupt processing program.

| Command/ | First parameter/ | |
|---|---|---|
| SMI | second | Returned system information/action/ |
| mechanism | parameter | corresponding procedure in SMI handler |
| ADh | 0/NA | Port B3h/Get EBDA memory base address |
| (IO/ | | (high byte), low byte always is 0. |
| MMIO | | (EX: 9800h)/GetEbdaMemBaseAddr |
| base | | |
| address)/ | | |
| SW SMI | | |

Tables 4 is a reference table showing the first parameter, the second parameter and the system information when the command is FCh in the interrupt processing program.

| Command/ | | Returned system information/action/ |
|---|---|---|
| SMI | First parameter/ | corresponding procedure in |
| mechanism | second parameter | SMI handler |
| FCh | 0/NA | EBDA/Get BIOS POST information/ |
| (EBDA-related | | GetBiosPostInfo |
| command)/ | | |
| SW SMI | | |
| FCh | 1/4 bytes | NA/Set the power Led status/ |
| (EBDA-related | byte1: LED status | SetPwrLedSts |
| command)/ | type | |
| Both | 0 - LED off | |
| | 1 - LED ON | |
| | 2 - LED blink | |
| | Byte2: Led color | |
| | 0 - Green | |
| | 1 - Amber | |
| | 2 - Red | |
| | byte3: The blink | |
| | frequency in | |
| | 0.1 sec | |
| | byte4: LED on | |
| | duty in % | |
| | (0~100) | |

Tables 5 is a reference table showing the first parameter, the second parameter and the system information when the command is FBh in the interrupt processing program.

| Command/ | | Returned system information/action/ |
|---|---|---|
| SMI | First parameter/ | corresponding procedure in |
| mechanism | second parameter | SMI handler |
| FB | 0 (system state S0)/ | NA/Notify BMC of system state S0/ |
| (System | NA | NotifyBmcSysSts |
| Status)/ | | |
| Both | | |
| FB | 1 (system state S1)/ | NA/Notify BMC of system state S1/ |
| (System | NA | NotifyBmcSysSts |
| Status)/ | | |
| Both | | |
| FB | 2 (system state S0)/ | NA/Notify BMC of system state S2/ |
| (System | NA | NotifyBmcSysSts |
| Status)/ | | |
| Both | | |
| FB | 3 (system state S3)/ | NA/Notify BMC of system state S3/ |
| (System | NA | NotifyBmcSysSts |
| Status)/ | | |
| Both | | |
| FB | 4(system state S4)/ | NA/Notify BMC of system state S4/ |
| (System | NA | NotifyBmcSysSts |
| Status)/ | | |
| Both | | |
| FB | 5 (system state S5)/ | NA/Notify BMC of system state S5/ |
| (System | NA | NotifyBmcSysSts |
| Status)/ | | |
| Both | | |

Tables 6 is a reference table showing the first parameter, the second parameter and the system information when the command is FAh in the interrupt processing program.

| Command/ | | Returned system information/action/ |
|---|---|---|
| SMI | First parameter/ | corresponding procedure in |
| mechanism | second parameter | SMI handler |
| FAh | 0/1byte | NA/sending running OS type to SMI |
| (Sending | 0 - Windows XP | handler in BIOS from OS of ACPI/ |
| information | 1 - Windows 2003 | SendRunningOsType |
| to SMI | 32 bit | |
| processing | 2 - Windows 2003 | |
| program)/ | 64 bit | |
| SW SMI | 3 - Windows 2000 | |
| | 4 - NT 4.0 | |
| | 5 - Redhat Linux | |
| | EL5 AS | |
| | 6 - Fedora Core 8 | |

According to the present embodiment, an ASL program language used by the configuration management program module 630 includes an SMI calling command, wherein a format thereof is, for example, CALL_SMI (command, input data, output data), “command” is the command, “input data” is the first parameter and “output data” is the system information. In addition, a program calling an interface using the SW SMI is described in the following.

```
Method (SSMI,2)  // SW SMI => Call_SMI
(command, input data, output data)
                  // Arg0 - command; Arg1 - Input Data;
                  Local1 - Ouput Data
{
Mutex (MUT1, 0)  // MUTEX for SMIS(IO 0x B3) & SMIC (IO 0xB2)
Acquire(MUT1, 0xFFFF)  // Acquire Semaphore
Store(\_SB.SMIS, Local0)  // Save SMIS
Store(Arg1,\_SB.SMIS)  // Set parameter into SMIS
Store(Arg0,\_SB.SMIC)  // SW SMI command into SMIC;
                          issue SW SMI & return value will
                          save to IO 0xB3
Store(\_SB.SMIS , Local1)
Store(Local0, \_SB.SMIS)  // Restore SMIS
Release(MUT1) // Release Semaphore
Return (Local1) // Output Data
}  // end SSMI
```

Furthermore, a program calling an interface using a sleep SMI is described in the following.

```
Method (LSMI,1)  // Sleep-Type SMI => Call_SMI (command)
Arg0 - Command
{
  Store(Arg1,\_SB.SMIS)  // Set parameter into SMIS
  Store(One, PS1S)  // Clear Sleep status
  Store(One, PS1E)  // Enable Sleep
  // After here, system will issue “Sleep SMI”if “sleep type enable bit” is
  set as 1
}  // end LSMI
```

The invention provides a computer accessible storage medium used for storing a computer program. The computer program is loaded into the computer system and enables the computer system to execute the above method for the configuration management program transmitting the system information.

The present invention provides a product of a computer program which is used to execute the method for the configuration management program transmitting the system information. The product of the computer program substantially includes a plurality of portions of codes, and after the portions of the codes are loaded to and executed in the computer, the above step of the configuration management program transmitting the system information is completed.

In summary, the present invention first stores the system information obtained by testing the computer system in the memory. Then, by enabling the interrupt from the configuration management program, the interrupt processing program processes the interrupt, so as to perform the corresponding configuration setting operation according to the command information in the interrupt or to return the corresponding system information in the memory to the configuration management program according to the command information in the interrupt, so that the configuration management program obtains the corresponding system information. Therefore, if a chipset in the computer system need to be replaced, a hardware design needs to be modified or the codes of the BIOS need to be corrected, a computer engineer only needs to correct the related codes of the BIOS, and does not need to correct the ASL codes related to the configuration management program, thereby reducing errors in writing the ASL codes and debugging time.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for a configuration management program transmitting a system information, comprising:
providing a first memory, wherein the first memory records at least one system information;
enabling an interrupt from the configuration management program, wherein the interrupt has a command information; and
processing the interrupt by an interrupt processing program, so as to perform a corresponding configuration setting operation according to the command information or to return the corresponding system information in the first memory to the configuration management program according to the command information.

2. The method for the configuration management program transmitting the system information of claim 1, further comprising:
testing a computer system to obtain at least a system information; and
recording the system information in the first memory.

3. The method for the configuration management program transmitting the system information of claim 2, wherein the step of testing the computer system comprises:
performing a power-on self-test procedure; and
in the power-on self-test procedure, testing a configuration of the computer system by a basic input output system to obtain the system information.

4. The method for the configuration management program transmitting the system information of claim 1, wherein the interrupt is a system management interrupt, and the interrupt processing program is a system management interrupt handler.

5. The method for the configuration management program transmitting the system information of claim 1, wherein the command information comprises a command, and the step of enabling the interrupt from the configuration management program comprises:
writing the command to an interrupt control port,
wherein the interrupt processing program executes the command in the interrupt control port, so as to perform the corresponding configuration setting operation according to the command or to return the corresponding system information in the first memory to the configuration management program according to the command.

6. The method for the configuration management program transmitting the system information of claim 1, wherein the command information comprises a command and a first parameter, and the step of enabling an interrupt from the configuration management program comprises:
writing the first parameter to an interrupt data port; and
writing the command to an interrupt control port,
wherein the interrupt processing program executes the command in the interrupt control port according to the first parameter in the interrupt data port, so as to perform the corresponding configuration setting operation according to the first parameter and the command or to write the corresponding system information in the first memory to the interrupt data port according to the first parameter and the command.

7. The method for the configuration management program transmitting the system information of claim 6, further comprising:
reading the system information from the interrupt data port by the configuration management program.

8. The method for the configuration management program transmitting the system information of claim 6, wherein the interrupt data port is an input output port having an address of B3h.

9. The method for the configuration management program transmitting the system information of claim 6, wherein the interrupt control port is an input output port having an address of B2h.

10. The method for the configuration management program transmitting the system information of claim 6, further comprising:
writing a second parameter to a second memory,
wherein the interrupt processing program executes the command in the interrupt control port according to the first parameter in the interrupt data port and the second parameter in the second memory, so as to perform the corresponding configuration setting operation according to the first parameter, the second parameter and the command or to write the corresponding system information in the first memory to the second memory according to the first parameter, the second parameter and the command.

11. The method for the configuration management program transmitting the system information of claim 10, further comprising:
reading the system information from the second memory by the configuration management program.

12. The method for the configuration management program transmitting the system information of claim 10, wherein the second memory is an extended basic input output system data area.

13. The method for the configuration management program transmitting the system information of claim 1, wherein the first memory is a system management mode memory.

14. The method for the configuration management program transmitting the system information of claim 1, wherein the configuration management program is a program of an advanced configuration and power interface.

15. A computer accessible storage medium used for storing a computer program, wherein the computer program is used to be loaded to a computer system so that the computer system executes the method for the configuration management program transmitting the system information of claim 1.

16. A product of a computer program used for a configuration management program transmitting a system information, after a computer loads and executes the computer program, completing the method for the configuration management program transmitting the system information of claim 1.

17. A computer system, comprising:
a first memory, for recording a system information;
a configuration management program module, for executing a configuration management program, so as to enable an interrupt, wherein the interrupt has a command information; and
an interrupt processing program module, for executing an interrupt processing program to process the interrupt, so as to perform a corresponding configuration setting operation according to the command information or to return the corresponding system information in the first memory to the configuration management program module according to the command information.

18. The computer system of claim 17, further comprising a testing module used to test the computer system, so as to obtain at least one system information and to record the system information in the first memory.

19. The computer system of claim 18, wherein the testing module performs a power-on self-test procedure, and in the power-on self-test procedure, a basic input output system tests a configuration of the computer system, so as to obtain the system information.

20. The computer system of claim 17, wherein the interrupt is a system management interrupt, and the interrupt processing program is a system management interrupt handler.

21. The computer system of claim 17, wherein the command information comprises a command, the computer system further comprising an interrupt control port used to store the command, wherein the interrupt processing program module executes the command in the interrupt control port, so as to perform the corresponding configuration setting operation according to the command or to return the corresponding system information in the first memory to the configuration management program module according to the command.

22. The computer system of claim 17, wherein the command information comprises a command and a first parameter, the computer system further comprising:
an interrupt data port, for storing the first parameter; and
an interrupt control port, for storing the command,
wherein the interrupt processing program module executes the command in the interrupt control port according to the first parameter in the interrupt data port, so as to perform the corresponding configuration setting operation according to the first parameter and the command or to write the corresponding system information in the first memory to the interrupt data port according to the first parameter and the command.

23. The computer system of claim 22, wherein the configuration management program module reads the system information from the interrupt data port.

24. The computer system of claim 22, wherein the interrupt data port is an input output port having an address of B3h.

25. The computer system of claim 22, wherein the interrupt control port is an input output port having an address of B2h.

26. The computer system of claim 22, further comprising a second memory used to store a second parameter, wherein the interrupt processing program module executes the command in the interrupt control port according to the first parameter in the interrupt data port and the second parameter in the second memory, so as to perform the corresponding configuration setting operation according to the first parameter, the second parameter and the command or to write the corresponding system information in the first memory to the second memory according to the first parameter, the second parameter and the command.

27. The computer system of claim 26, wherein the configuration management program module reads the system information from the second memory.

28. The computer system of claim 26, wherein the second memory is an extended basic input output system data area.

29. The computer system of claim 17, wherein the first memory is a system management mode memory.

30. The computer system of claim 17, wherein the configuration management program is a program of an advanced configuration and power interface.

31. A method for a configuration management program transmitting a system information, comprising:
performing a power-on self-test procedure;
in the power-on self-test procedure, testing a configuration of the computer system by a basic input output system to obtain at least one system information;
providing a first memory to records the at least one system information;
writing the first parameter to an interrupt data port;
writing the command to an interrupt control port;
writing a second parameter to a second memory, wherein the interrupt processing program executes the command in the interrupt control port according to the first parameter in the interrupt data port and the second parameter in the second memory, so as to perform the corresponding configuration setting operation according to the first parameter, the second parameter and the command or to write the corresponding system information in the first memory to the second memory according to the first parameter, the second parameter and the command; and
reading the system information from the second memory by the configuration management program.
